(19) United States
(12) Patent Application Publication
(10) Pub. No.: US 2009/0066808 A1
(43) Pub. Date: Mar. 12, 2009

(54) IMAGE-DATA PROCESSING APPARATUS AND DATA-PROCESSING CIRCUIT

(75) Inventor: Mitsuaki KUROKAWA, Toyonaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/207,999

(22) Filed: Sep. 10, 2008

(30) Foreign Application Priority Data
Sep. 11, 2007 (JP) 2007-235499
Sep. 11, 2007 (JP) 2007-235703

(51) Int. Cl. H04N 5/76

(52) U.S. Cl. 348/231.2; 348/E07.085

(57) ABSTRACT

An image-data processing apparatus includes a pre-processing circuit for repeatedly fetching image data representing an object scene. A post-processing circuit, a video display circuit, and an H264 encoder perform a moving-image process according to a designated mode, on the image data fetched by the pre-processing circuit. The post-processing circuit and a JPEG encoder perform a still-image process on one portion of the image data fetched by the pre-processing circuit. Two memory control circuits access two SDRAMs, respectively, in order to write and/or read out the image data related to the moving-image process and the image data related to the still-image process. A CPU changes a memory control circuit responsible for a memory access operation of the image data related to the still-image process, between the two memory control circuits depending upon the designated mode.

### CROSS REFERENCE OF RELATED APPLICATION

The disclosure of Japanese Patent Application Nos. 2007-235703 and 2007-235499 which were filed on Sep. 11, 2007 is incorporated herein by reference.

### BACKGROUND OF THE INVENTION

1. Field of the Invention

The present invention relates to an image-data processing apparatus. More particularly, the present invention relates to an image-data processing apparatus that performs a moving-image process and a still-image process on image data representing an object scene.

The present invention relates also to a data-processing circuit. More particularly, the present invention relates to a data-processing circuit that executes data writing and data reading-out on any one of a plurality of memory devices.

2. Description of the Related Art

According to one example of this type of an image-data processing apparatus or a data-processing circuit, image data of a document, which is read by an image input device, is once saved in a memory, and thereafter, outputted to a printer engine for printing out on a piece of paper. The image data saved in the memory is also compressed by a compressor, and the compressed image data is saved on an HDD via the memory. The memory has an input/output region for storing the image data read by the image input device and a saving region for storing the image data compressed by the compressor. Such inputting/outputting of the image data to and from the memory is mediated by an arbiter.

However, in the above-described example, whether either one of the image data is stored in the input/output region and the other one of the image data is stored in the saving region are fixed in advance. That is, a storing destination of the image data to be noticed is not changed between the input/output region and the saving region depending upon an operation situation. Thus, in the above-described example, there is a probability that a load charged to a memory-access operation is deviated to either one of the regions.

### SUMMARY OF THE INVENTION

An image-data processing apparatus according to the present invention comprises: a fetcher for repeatedly fetching image data representing an object scene; a moving-image processor for performing a moving-image process on the image data fetched by the fetcher; a still-image processor for performing a still-image process on one portion of the image data fetched by the fetcher; a plurality of accessors for respectively accessing a plurality of memories to write and/or read out the image data related to the process of each of the moving-image processor and the still-image processor; and a changer for changing between the plurality of accessors a specific accessor responsible for a memory access operation of the image data related to the process of the still-image processor, depending upon a process amount of the moving-image processor.

Preferably, there is further provided a determiner for determining whether or not the process amount of the moving-image processor changes, in which the changer executes a change process when a determination result of the determiner is updated from a negative result to an affirmative result.

Preferably, the fetcher fetches one screen of image data at each generation of a timing signal, and the changer executes a change process in synchronous with the timing signal.

Preferably, the process amount of the moving-image processor differs depending upon an operation mode, and the changer changes the specific accessor according to the operation mode.

Further preferably, the moving-image processor includes: a convertor for converting a resolution of the image data fetched by the fetcher; a displayer for displaying an image based on the image data having the resolution converted by the convertor; and a first encoder for encoding, for recording, the image data having the resolution changed by the changer. There is further provided a controller for starting the first encoder when a moving-image recording mode is designated whereas stopping the first encoder when a moving-image displaying mode is designated.

Further preferably, the plurality of accessors include a moving-image-use accessor responsible for memory access operations of both of the image data having the resolution converted by the convertor and the image data encoded by the first encoder, and the changer renders the specific accessor, an accessor different from the moving-image-use accessor, when the moving-image recording mode is designated, and renders the specific accessor, the same accessor as the moving-image-use accessor, when the moving-image displaying mode is designated.

In a certain aspect, the plurality of accessors further include a fetched-image-use accessor that is different from the moving-image-use accessor and is responsible for a memory access operation of the image data fetched by the fetcher.

Preferably, the still-image processor includes an extractor for extracting one portion of the image data fetched by the fetcher and a second encoder for encoding, for recording, the image data extracted by the extractor.

Further preferably, the extractor extracts image data representing an object scene at a time of issuing a recording instruction.

Preferably, there is further provided an imager, having an imaging surface irradiated with an optical image of an object scene, for repeatedly generating image data corresponding to the optical image, in which the fetcher fetches the image data outputted from the imager.

A data-processing circuit according to the present invention comprises: a plurality of data buses respectively connected to a plurality of memory devices; a first holder for holding first identification information for identifying, out of the plurality of memory devices, a memory device of a data-writing destination; a second holder for holding second identification information for identifying, out of the plurality of memory devices, a memory device of a data-reading source; a plurality of outputters, each of which executes a data-output process for outputting data from an output end corresponding to the first identification information held by the first holder, out of a plurality of output ends respectively connected to the plurality of data buses; and a plurality of inputters, each of which executes a data-input process for inputting data from an input end corresponding to the second identification information held by the second holder, out of a plurality of input ends respectively connected to the plurality of data buses.

Preferably, there is further provided a fetcher for fetching desired data, in which the plurality of outputters include a fetched-data outputter for performing the data-output process on the data fetched by the fetcher.

Preferably, there is further provided a first convertor for performing a first converting process on desired data, in wherein the plurality of inputters include a first conversion data inputter for inputting data to be converted by the first convertor.

Further preferably, the plurality of outputters include a first conversion data outputter for performing the data-output process on data converted by the first convertor.

Preferably, there is further provided an external outputter for outputting desired data to outside, in which the plurality of inputters include an external-output-data inputter for inputting data to be outputted by the external outputter.

Preferably, there is further provided a second convertor for performing a second converting process on desired data, in which the plurality of inputters include a second conversion data inputter for inputting data to be converted by the second convertor.

Further preferably, the plurality of outputters include a second conversion data outputter for performing the data-output process on data converted by the second convertor.

The above described features and advantages of the present invention will become more apparent from the following detailed description of the embodiment of the present invention when taken in conjunction with the accompanying drawings.

### BRIEF DESCRIPTION OF THE DRAWINGS

FIG. 1 is a block diagram showing one example of a configuration of a video camera according to this embodiment;

FIG. 2(A) is a timing chart showing one example of an output operation of a pre-processing circuit;

FIG. 2(B) is a timing chart showing one example of a moving-image output operation of a post-processing circuit;

FIG. 2(C) is a timing chart showing one example of a still-image output operation of the post-processing circuit;

FIG. 3 is a block diagram showing one example of a configuration of a pre-processing circuit applied to an embodiment in FIG. 1;

FIG. 4 is a block diagram showing one example of a configuration of a post-processing circuit applied to the embodiment in FIG. 1;

FIG. 5 is a block diagram showing one example of a configuration of a video display circuit applied to the embodiment in FIG. 1;

FIG. 6 is a block diagram showing one example of a configuration of a character display circuit applied to the embodiment in FIG. 1;

FIG. 7 is a block diagram showing one example of a configuration of an H264 encoder applied to the embodiment in FIG. 1;

FIG. 8 is a block diagram showing one example of a configuration of a JPEG encoder applied to the embodiment in FIG. 1; and

FIG. 9 is a flowchart showing one portion of an operation of a CPU applied to the embodiment in FIG. 1.

### DETAILED DESCRIPTION OF THE PREFERRED EMBODIMENTS

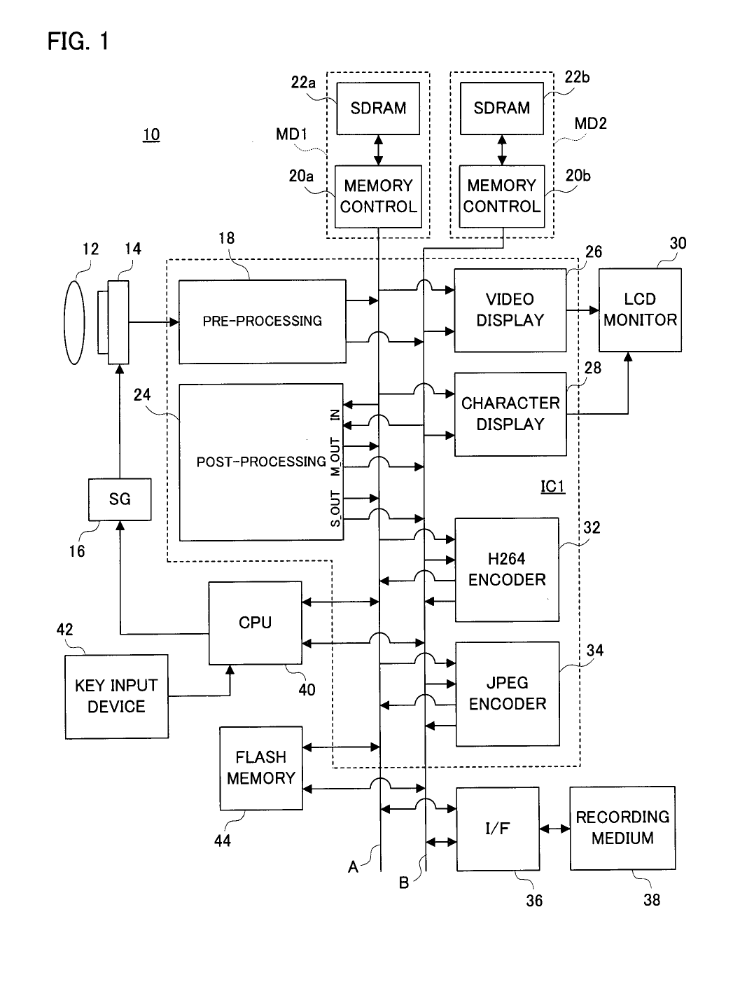

With reference to FIG. 1, a video camera 10 according to this embodiment includes an optical lens 12. An optical image of an object scene is irradiated onto an imaging surface of a CMOS-type imaging device 14 via the optical lens 12. A plurality of pixels are two-dimensionally arrayed on the imaging surface, and in each pixel, electric charges according to a light amount are generated. It is noted that the imaging surface is covered with a primary color filter (not shown) having a Bayer array, and the electric charges generated in each pixel has color information of R (red), G (green), or B (blue).

When a power source is turned on, a CPU 40 applies corresponding instructions to the imaging device 14, a pre-processing circuit 18, a post-processing circuit 24, and a video display circuit 26 in order to execute a through-image process under an imaging task.

The imaging device 14 exposes the imaging surface in response to a vertical synchronization signal Vsync outputted from an SG (signal generator) 16, and reads out the electric charges generated by the exposure on the imaging surface in a raster scanning manner. The imaging surface has a resolution (the number of pixels) of 6 million pixels, and the vertical synchronization signal Vsync is outputted at each 1/30 seconds. From the imaging device 14, raw image data of 6 million pixels based on the electric charges generated on the imaging surface is outputted at a frame rate of 30 fps.

A data-processing circuit IC1 utilizes memory devices MD1 and MD2, which are connected to data buses A and B, respectively, so as to perform various data processes on the raw image data outputted from the imaging device 14. The following descriptions will refer to Table 1, which shows an allocation state of the memory devices MD1 and MD2, for convenience of description.

TABLE 1

| | Pre- | Post-process | | | Video | | | Character |
|---|---|---|---|---|---|---|---|---|
| | process | IN | M_OUT | S_OUT | display | H264 | JPEG | display |
| Through-image | MD1 | MD1 | MD2 | — | MD2 | — | — | MD1 |
| display | | | | | | | | (or MD2) |
| Still image recording | MD1 | MD1 | MD2 | MD2 | MD2 | — | MD2 | MD1 |
| (through-image being | | | | | | | | (or MD2) |
| displayed) | | | | | | | | |
| Moving image | MD1 | MD1 | MD2 | — | MD2 | MD2 | — | MD1 |
| recording | | | | | | | | (or MD2) |
| Still image recording | MD1 | MD1 | MD2 | MD1 | MD2 | MD2 | MD1 | MD1 |
| (moving image being | | | | | | | | (or MD2) |
| recorded) | | | | | | | | |
| The number of pixels | 6M | 6M | 2M | 6M | 2M | 2M | 6M | — |

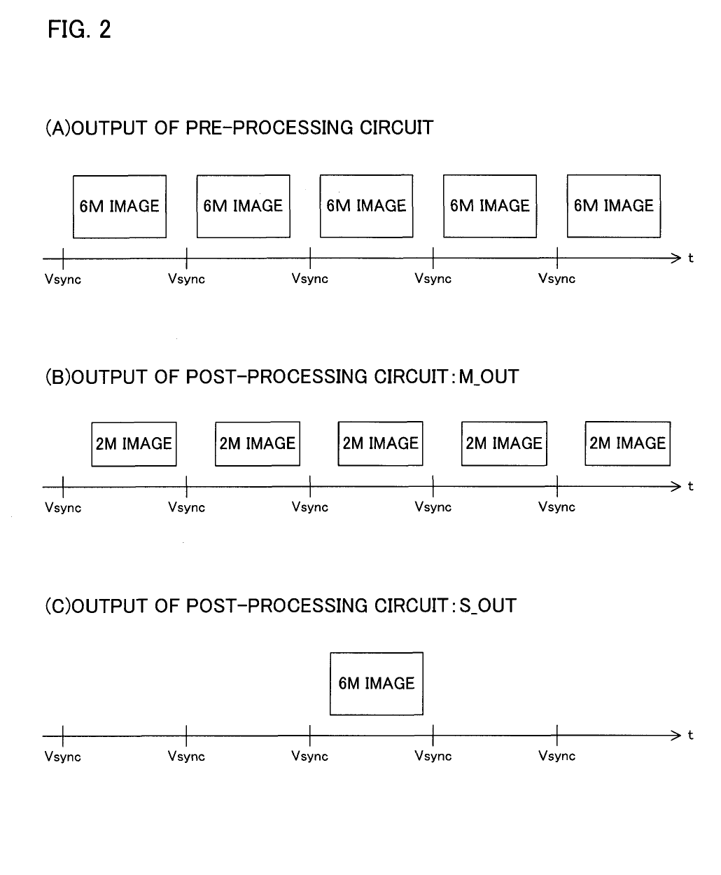

The pre-processing circuit 18 performs processes, such as digital clamp, a pixel-defect correction, and gain control, on the raw image data outputted from the imaging device 14 and outputs the processed raw image data to the data bus A according to a procedure shown in FIG. 2(A). The raw image data outputted to the data bus A is applied to a memory control circuit 20a configuring the memory device MD1, and is written to an SDRAM 22a by the memory control circuit 20a.

The post-processing circuit 24 reads out the raw image data accommodated in the SDRAM 22a through the memory control circuit 20a at each 1/30 seconds. The read-out raw image data is inputted via the data bus A to an input terminal IN of the post-processing circuit 24, and is subjected to processes such as a color separation, a white balance adjustment, a YUV conversion, zooming-out. As a result, YUV image data equivalent to 2 million pixels is outputted to the data bus B from a moving-image output terminal M_OUT according to a procedure shown in FIG. 2(B). The YUV image data outputted to the data bus B is applied to a memory control circuit 20b configuring the memory device MD2, and is written to an SDRAM 22b by the memory control circuit 20b.

The video display circuit 26 reads out the YUV image data accommodated in the SDRAM 22b through the memory control circuit 20b at each 1/30 seconds. The read-out YUV image data is inputted to the video display circuit 26 via the data bus B. The video display circuit 26 drives an LCD monitor 30 based on the inputted YUV image data, and thereby, a real-time moving image representing the object scene, i.e., a through image, is displayed on a monitor screen.

When a still-image recording operation is performed by a key input device 42 in a middle of a through-image process (a moving-image recording task described later is in a stopped state), the CPU 40 applies corresponding instructions to the post-processing circuit 24, a JPEG encoder 34, and an I/F circuit 36 in order to execute the still-image recording process.

The post-processing circuit 24 extracts one frame of the YUV image data representing the object scene image at a time that the still-image recording operation is performed. The extracted YUV image data is image data equivalent to 6 million pixels before being subjected to a zooming-out process (reduction process) and is outputted to the data bus B from a still-image output terminal S_OUT according to a procedure shown in FIG. 2(C). The outputted YUV image data is applied to the memory control circuit 20b via the data bus B and is written to the SDRAM 22b by the memory control circuit 20b.

The JPEG encoder 34 reads out one frame of the YUV image data accommodated in the SDRAM 22b through the memory control circuit 20b, inputs the read-out YUV image data via the data bus B, and performs a compression process according to a JPEG method, on the inputted YUV image data. The JPEG-compressed image data, i.e., JPEG data, is applied to the memory control circuit 20b via the data bus B and is written to the SDRAM 22b by the memory control circuit 20b.

The I/F circuit 36 reads out one frame of the JPEG data accommodated in the SDRAM 22b through the memory control circuit 20b, inputs the read-out JPEG data from the data bus B, and records the inputted JPEG data in a recording medium 38 in a file format. Thereby, a still-image file containing the object scene image at a time of performing the still-image recording operation is obtained within the recording medium 38.

When a moving-image-recording start operation is performed by the key input device 42 in a middle of the through-image process, the CPU 40 starts a moving-image recording task in parallel with the imaging task and applies processing instructions to an H264 encoder 32 and the I/F 36 under the started moving-image recording task.

The H264 encoder 32 reads out the YUV image data, which is equivalent to 2 million pixels and is accommodated in the SDRAM 22b, through the memory control circuit 20b at each 1/30 seconds, inputs the read-out YUV image data from the data bus B, and performs a compression process on the inputted YUV image data according to an H264 format. The H264-compressed image data, i.e., H264 data, is applied to the memory control circuit 20b via the data bus B and is written to the SDRAM 22b by the memory control circuit 20b.

The I/F circuit 36 reads out a plurality of frames of H264 data, accumulated in the SDRAM 22b, through the memory control circuit 20b, inputs the read-out H264 data from the data bus B, and records the inputted H264 data on the recording medium 38 in a file format. The plurality of frames of H264 data, generated in response to the moving-image-recording start operation, is being accumulated in the same moving-image file within the recording medium 38. When a moving-image-recording end operation is performed on the key input device 42, the moving-image recording task is stopped. Once the moving-image recording task is stopped, the abovementioned operations performed by the H264 encoder 32 and the I/F circuit 36 are also stopped. Thereby, the moving-image file is completed.

When the still-image recording operation is performed by the key input device 42 in a middle of a startup of the moving-image recording task, the CPU 40 applies corresponding instructions to the post-processing circuit 24, the JPEG encoder 34, and the I/F circuit 36 in order to execute the still-image recording process. However, at this time, the H264 encoder 32 uses the memory device MD2 under the moving-image recording task, so that when the memory device MD2 is allocated to the still-image output terminal S_OUT of the post-processing circuit 24 and the JPEG encoder 34, a load charged to a memory access operation results in being deviated to the memory device MD2.

To avoid this deviation, in this embodiment, when the still-image recording operation is performed in a middle of a startup of the moving-image recording task, the memory device MD1 is allocated to the still-image output terminal S_OUT of the post-processing circuit 24 and the JPEG encoder 34. As a result, the post-processing circuit 24, the JPEG encoder 34, and the I/F circuit 36 operate as follows:

The post-processing circuit 24 outputs one frame (resolution: 6 million pixels) of the YUV image data representing the object scene image at a time that the still-image recording operation is performed, from the still-image output terminal S_OUT to the data bus A. The YUV image data outputted to the data bus A is applied to the memory control circuit 20a and is written to the SDRAM 22a by the memory control circuit 20a.

The JPEG encoder 34 reads out one frame of the YUV image data accommodated in the SDRAM 22a through the memory control circuit 20a, inputs the read-out YUV image data from the data bus A, and performs a JPEG compression on the inputted YUV image data. The JPEG data obtained by the JPEG compression is applied to the memory control circuit 20a via the data bus A and is written to the SDRAM 22a by the memory control circuit 20a.

The I/F circuit 36 reads out the JPEG data accommodated in the SDRAM 22a through the memory control circuit 20a, inputs the read-out JPEG data from the data bus A, and creates a still-image file containing the inputted JPEG data within the recording medium 38.

The CPU 40 writes character codes corresponding to the various operations described above to the SDRAM 20a (or 20b) through the memory control circuit 20a (or 20b) under a character-controlling task executed in parallel with the imaging task. A character display circuit 28 reads out the character codes accommodated in the SDRAM 22a (or 22b) through the memory control circuit 20a (or 20b), inputs the read-out character codes from the data bus A (or B), and drives the LCD monitor 30 based on the inputted character codes. As a result, characters, which guide the various operations described above, are displayed on the monitor screen in an OSD manner.

In the following description, a mode in which the through-image process is started while the moving-image recording task is stopped is defined as a “moving-image displaying mode”, and a mode in which both the through-image process and the moving-image recording task are started is defined as a “moving-image recording mode”.

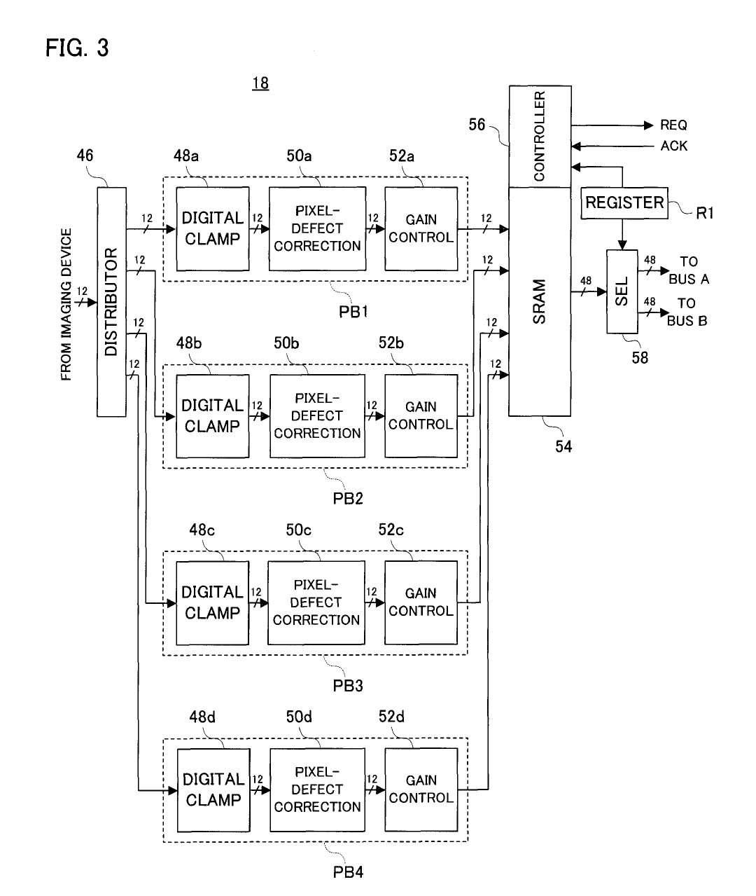

The pre-processing circuit 18 is configured as shown in FIG. 3. The raw image data outputted 14 in a raster scanning manner from the imaging device 14 is applied to a distributor 46. The distributor 46 divides the applied raw image data into four blocks in a horizontal direction and inputs four blocks of the divided raw image data to pre-processing blocks PB1 to PB4, respectively.

The pre-processing block PB1 is configured by: a digital clamp circuit 48a; a pixel-defect correction circuit 50a; and a gain control circuit 52a, and the pre-processing block PB2 is configured by: a digital clamp circuit 48b; a pixel-defect correction circuit 50b; and a gain control circuit 52b. Furthermore, the pre-processing block PB3 is configured by: a digital clamp circuit 48c; a pixel-defect correction circuit 50c; and a gain control circuit 52c, and the pre-processing block PB4 is configured by: a digital clamp circuit 48d; a pixel-defect correction circuit 50d; and a gain control circuit 52d.

Therefore, the raw image data in any block is commonly subjected to digital clamp, a pixel-defect correction, and gain control. The raw image data outputted from the pre-processing blocks PB1 to PB4 are thereafter written to an SRAM 54.

A controller 56 issues a writing request toward the memory control circuit 20a or 20b each time an amount of data accommodated in the SRAM 54 reaches a threshold value, and reads out a predefined amount of raw image data from the SRAM 54 when an acknowledge signal is returned from an issuance destination. A selector 58 has two output terminals respectively connected to the data buses A and B and outputs the read-out raw image data from one of these two output terminals.

The controller 56 references a register R1 to specify the issuance destination of the writing request, and the selector 58 references the register R1 to specify an output destination of the raw image data. In the register R1, identification information for identifying the memory device MD1 is registered. Therefore, the writing request is issued toward the memory control circuit 20a configuring the memory device MD1, and the raw image data read out from the SRAM 54 is outputted to the data bus A.

It is noted that each pixel forming the raw image data is expressed by 12 bits, and the 12-bit pixel data outputted from each of the pre-processing blocks PB1 to PB4 is written to the SRAM 54 in a time-division manner. However, 48-bit pixel data equivalent to horizontal four pixels is simultaneously read out from the SRAM 54.

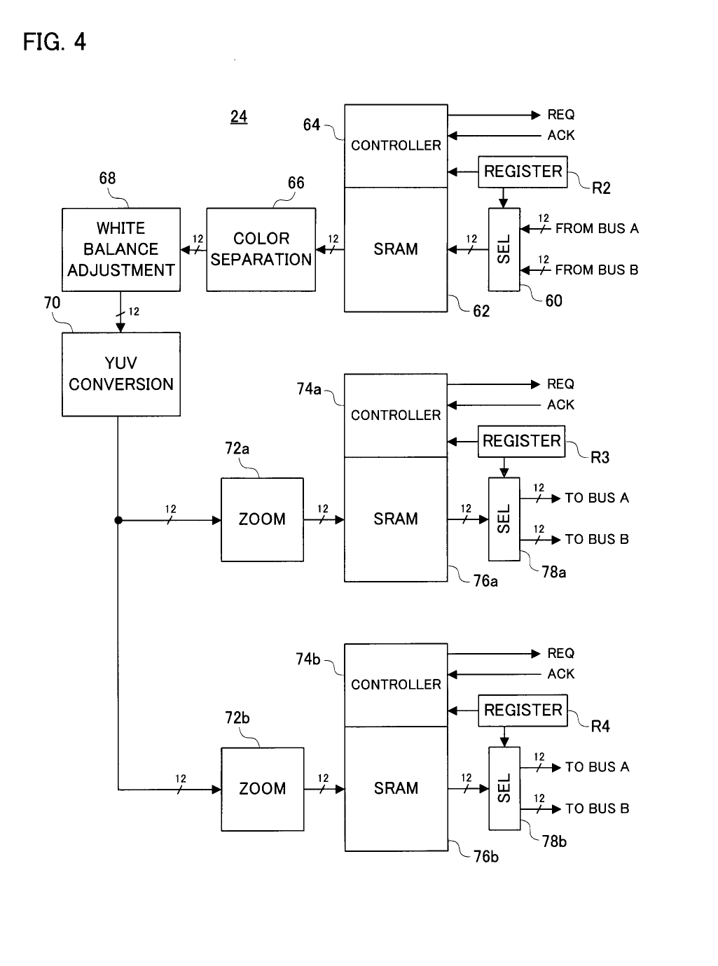

The post-processing circuit 24 is configured as shown in FIG. 4. A controller 64 issues a reading-out request toward the memory control circuit 20a or 20b each time an amount of data accommodated in the SRAM 62 falls below a threshold value and executes a data writing to the SRAM 62 when an acknowledge signal is returned from the issuance destination. The raw image data to be written to the SRAM 62 is a predefined amount of data outputted from the issuance destination of the reading-out request and is transferred through the data bus A or B. A selector 60 has two input terminals respectively connected to the data buses A and B and one output terminal connected to the SRAM 62. The raw image data transferred through the data bus A or B is applied to the SRAM 62 via the selector 60.

The controller 64 references a register R2 to specify the issuance destination of the reading-out request, and the selector 60 references the register R2 to specify an input source of the raw image data. In the register R2, identification information indicating the memory device MD1 is registered. Therefore, the reading-out request is issued toward the memory control circuit 20a configuring the memory device MD1, and the raw image data is inputted to the selector 60 via the data bus A.

A color separation circuit 66 performs a color separation process on the raw image data accommodated in the SRAM 62. As a result, RGB image data in which each pixel has all color information of R, G, and B is generated. A white-balance adjusting circuit 68 adjusts a white balance of the RGB image data outputted from the color separation circuit 66, and a YUV conversion circuit 70 converts the RGB image data outputted from the white-balance adjusting circuit 68 into the YUV image data.

A zoom circuit 72a performs a zooming-out process (reduction process) on the YUV image data outputted from the YUV conversion circuit 70 so as to reduce a resolution (the number of pixels) from 6 million pixels to 2 million pixels. The YUV image data having the reduced resolution is written to the SRAM 76a.

Similar to the controller 54 shown in FIG. 3, a controller 74a issues a writing request toward the memory control circuit 20a or 20b each time an amount of data accommodated in the SRAM 76a reaches a threshold value and reads out a predefined amount of the YUV image data from the SRAM 76a when an acknowledge signal is returned from an issuance destination. A selector 78a has two output terminals respectively connected to the data buses A and B and outputs from one of these two output terminals the YUV image data read out from the SRAM 76a.

The controller 74a references a register R3 to specify the issuance destination of the writing request, and the selector 78a references the register R3 to specify an output destination of the YUV image data. In the register R3, identification information indicating the memory device MD2 is registered. Therefore, the writing request is issued toward the memory control circuit 20b configuring the memory device MD2, and the raw image data read-out from the SRAM 54 is outputted toward the data bus B.

A zoom circuit 72b extracts one frame of the YUV image data at a time that the still-image recording operation is performed and writes the extracted YUV image data, with the resolution being maintained at 6 million pixels, to an SRAM 76b. As described above, a controller 74b issues a writing request toward the memory control circuit 20a or 20b each time an amount of data accommodated in the SRAM 76b reaches a threshold value and reads out a predefined amount of the YUV image data from the SRAM 76b when an acknowledge signal is returned from an issuance destination. A selector 78b has two output terminals respectively connected to the data buses A and B and outputs the read-out YUV image data from one of these two output terminals.

The controller 74b references a register R4 to specify the issuance destination of the writing request, and the selector 78b references the register R4 to specify an output destination of the YUV image data. In the register R4, identification information of the memory device MD2 is registered corresponding to the moving-image displaying mode whereas identification information of the memory device MD1 is registered corresponding to the moving-image recording mode. Therefore, under the moving-image displaying mode, the writing request is issued toward the memory control circuit 20b configuring the memory device MD2, and the raw image data read out from the SRAM 54 is outputted toward the data bus B. In contrary thereto, under the moving-image recording mode, the writing request is issued toward the memory control circuit 20a configuring the memory device MD1, and the raw image data read out from the SRAM 54 is outputted toward the data bus A.

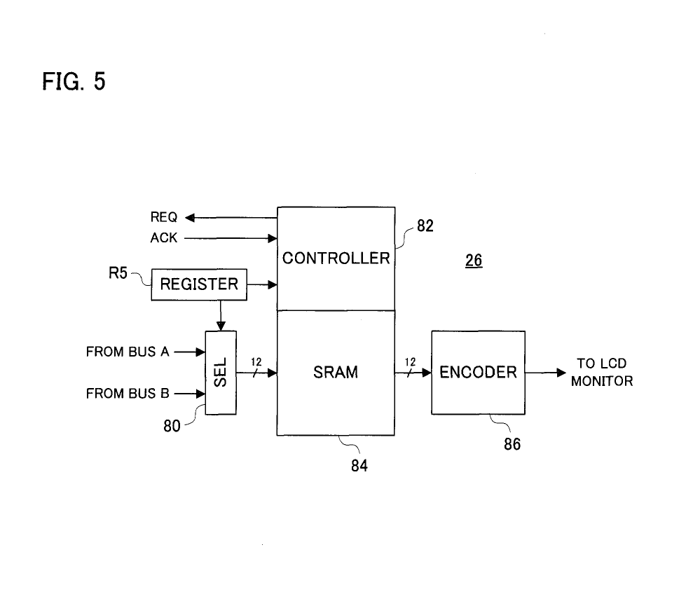

The video display circuit 26 is configured as shown in FIG. 5. Similar to the controller 64 shown in FIG. 4, a controller 82 issues a reading-out request toward the memory control circuit 20a or 20b each time an amount of data accommodated in an SRAM 84 falls below a threshold value and executes a data writing to the SRAM 84 when an acknowledge signal is returned from an issuance destination. The YUV image data to be written to the SRAM 84 is a predefined amount of data outputted from the issuance destination of the reading-out request, and is transferred through the data bus A or B. A selector 80 has two input terminals respectively connected to the data buses A and B and has one output terminal connected to the SRAM 84. The raw image data transferred through the data bus A or B is applied to the SRAM 84 via the selector 80.

The controller 82 references a register R5 to specify the issuance destination of the reading-out request, and the selector 80 references the register R5 to specify an input source of the YUV image data. In the register R5, identification information indicating the memory device MD2 is registered. Therefore, the reading-out request is issued toward the memory control circuit 20b configuring the memory device MD2, and the YUV image data is inputted via the data bus B to the selector 80. An encoder 86 performs a predetermined encoding process on the YUV image data accommodated in the SRAM 84 and outputs the encoded image signal toward the LCD monitor 30.

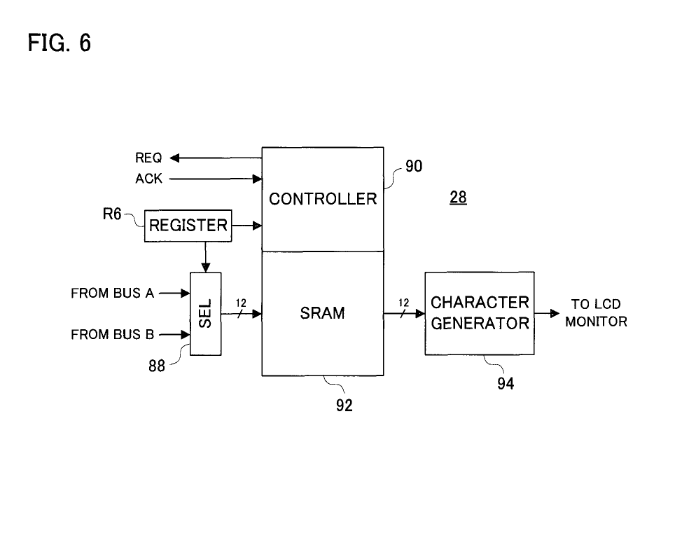

The video display circuit 26 is configured as shown in FIG. 6. Similar to the controller 82 shown in FIG. 5, a controller 90 issues a reading-out request toward the memory control circuit 20a or 20b each time an amount of data accommodated in an SRAM 92 falls below a threshold value and executes a data writing to the SRAM 92 when an acknowledge signal is returned from an issuance destination. Character codes to be written to the SRAM 92 are the predefined amount of codes outputted from the issuance destination of the reading-out request, and are transferred through the data bus A or B. A selector 88 has two input terminals respectively connected to the data buses A and B and has one output terminal connected to the SRAM 92. The character codes transferred through the data bus A or B are applied to the SRAM 92 via the selector 88.

The controller 90 references a register R6 to specify the issuance destination of the reading-out request, and the selector 88 references the register R6 to specify an input source of the character codes. In the register R6, identification information indicating the memory device MD1 (or MD2) is registered. Therefore, the reading-out request is issued toward the memory control circuit 20a (or 20b) configuring the memory device MD1 (or MD2), and the character codes are inputted to the selector 88 via the data bus A (or B). A character generator 94 creates character signals corresponding to the character codes accommodated in the SRAM 92 and outputs the created character signals toward the LCD monitor 30.

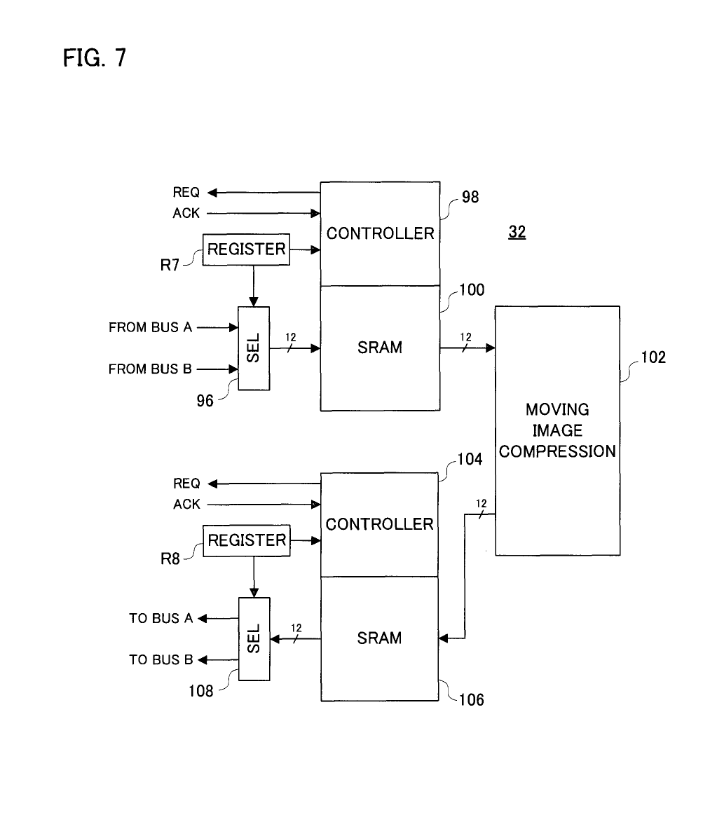

The H264 encoder 32 is configured as shown in FIG. 7. A controller 98 issues a reading-out request toward the memory control circuit 20a or 20b each time an amount of data accommodated in an SRAM 100 falls below a threshold value and executes a data writing to the SRAM 100 when an acknowledge signal is returned from an issuance destination. The YUV image data to be written to the SRAM 100 is a predefined amount of data outputted from the issuance destination of the reading-out request, and is transferred through the data bus A or B. A selector 96 has two input terminals respectively connected to the data buses A and B and has one output terminal connected to the SRAM 100. The YUV image data transferred through the data bus A or B is applied to the SRAM 100 via the selector 96.

A moving-image-compressing circuit 102 reads out the YUV image data accommodated in the SRAM 100, performs an H264 compression on the read-out YUV image data, and writes the H264 data to an SRAM 106. A controller 104 issues a writing request toward the memory control circuit 20a or 20b each time an amount of data accommodated in the SRAM 106 reaches a threshold value and reads out a predefined amount of the H264 data from the SRAM 106 when an acknowledge signal is returned from an issuance destination. A selector 108 has two output terminals respectively connected to the data buses A and B and outputs the read-out YUV image data from one of these two output terminals.

The controller 98 references a register R7 to specify the issuance destination of the reading-out request, and the selector 96 references the register R7 to specify an input destination of the YUV image data. Similarly, the controller 104 references a register R8 to specify the issuance destination of the writing request, and the selector 108 references the register R8 to specify an output destination of the H264 data. In each of the registers R7 and R8, identification information indicating the memory device MD2 is registered. Therefore, the read-out request and writing request are issued toward the memory control circuit 20b configuring the memory device MD2. Furthermore, the YUV image data is inputted to the selector 96 via the data bus B, and the H264 data read out from the SRAM 108 is outputted toward the data bus B.

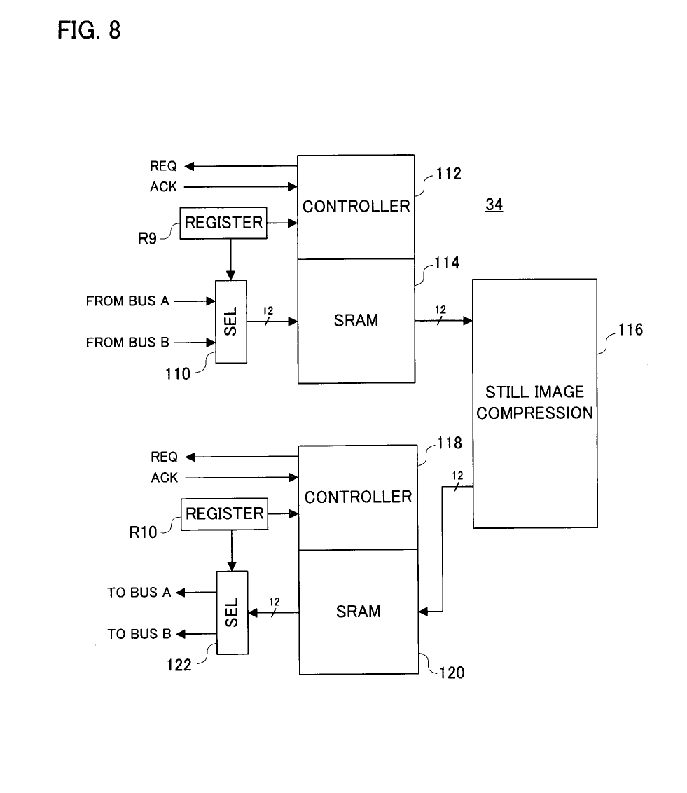

The JPEG encoder 34 is configured as shown in FIG. 8. A controller 112 issues a reading-out request toward the memory control circuit 20a or 20b each time an amount of data accommodated in an SRAM 114 falls below a threshold value and executes a data writing to the SRAM 114 when an acknowledge signal is returned from an issuance destination. The YUV image data to be written to the SRAM 114 is a predefined amount of data outputted from the issuance destination of the reading-out request, and is transferred through the data bus A or B. A selector 110 has two input terminals respectively connected to the data buses A and B and has one output terminal connected to the SRAM 114. The YUV image data transferred through the data bus A or B is applied to the SRAM 114 via the selector 110.

A still-image compressing circuit 116 reads out the YUV image data accommodated in the SRAM 114, performs a JPEG compression on the read-out YUV image data, and writes the JPEG data to an SRAM 120. A controller 118 issues a writing request toward the memory control circuit 20a or 20b each time an amount of data accommodated in an SRAM 120 reaches a threshold value and reads out a predefined amount of the JPEG data from the SRAM 120 when an acknowledge signal is returned from an issuance destination. A selector 122 has two output terminals respectively connected to the data buses A and B and outputs the read-out YUV image data from one of these two output terminals.

The controller 112 references a register R9 to specify the issuance destination of the reading-out request, and the selector 110 references the register R9 to specify an input destination of the YUV image data. Similarly, the controller 118 references a register R10 to specify the issuance destination of the writing request, and the selector 122 references the register R10 to specify an output destination of the JPEG data.

In each of the registers R9 and R10, identification information indicating the memory device MD2 is registered corresponding to the moving-image displaying mode whereas identification information indicating the memory device MD1 is registered corresponding to the moving-image recording mode. Therefore, in the moving-image displaying mode, the reading-out request and the writing request are issued toward the memory control circuit 20b configuring the memory device MD2. Furthermore, the YUV image data is inputted to the selector 110 via the data bus B and the JPEG data read out from the SRAM 120 is outputted toward the data bus B. Contrary thereto, in the moving-image recording mode, the reading-out request and the writing requests are issued toward the memory control circuit 20a configuring the memory device MD1. Furthermore, the YUV image data is inputted to the selector 110 via the data bus A, and the JPEG data read out from the SRAM 120 is outputted toward the data bus A.

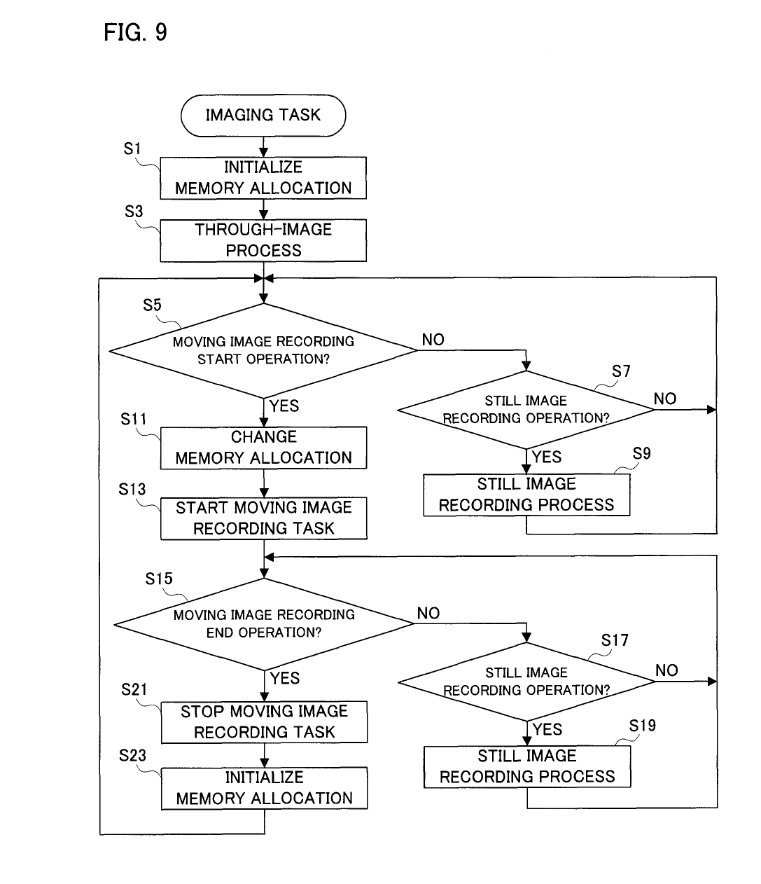

The CPU 40 executes a plurality of tasks including: the imaging task shown in FIG. 9; a moving-image recording task not shown; and a character-controlling task not shown, in a parallel manner. It is noted that control programs corresponding to these tasks are stored in a flash memory 44.

In a step S1 shown in FIG. 9, a memory allocation is initialized. The memory device MD1 is allocated to the pre-processing circuit 18, an input terminal IN of the post-processing circuit 24, and the character display circuit 28. Furthermore, the memory device MD2 is allocated to the moving-image output terminal M_OUT and the still-image output terminal S_OUT of the post-processing circuit 24, the video display circuit 26, and the JPEG encoder 34. More specifically, the identification information of the memory device MD1 is registered in the registers R1, R2, and R6, and the identification information of the memory device MD2 is registered in the registers R3, R4, R5, R9, and R10.

It is noted that a memory allocation to the H264 encoder 32 may be undetermined at this stage. Moreover, instead of the memory device MD1, the memory device MD2 may be allocated to the character display circuit 28.

In a step S3, the through-image process is executed. As a result, the through image of the object scene is displayed on the LCD monitor 30. In a step S5, it is determined whether or not the moving-image-recording start operation is performed, and in a step S7, it is determined whether or not the still-image recording operation is performed. When YES is determined in the step S7, the still-image recording process is executed in a step S9. As a result, the object scene image at a time of performing the still-image recording operation is recorded in the recording medium 38 in a file format. Upon completion of the process in the step S9, the process returns to the step S5.

When the moving-image-recording start operation is performed, the process proceeds from the step S5 to a step S11, in which the memory allocation is partially changed to adapt to the moving-image recording mode. More specifically, the memory device MD2 is allocated to the H264 encoder 32, and the memory device allocated to the still-image output terminal S_OUT of the post-processing circuit 24 and the JPEG encoder 34 is changed from “MD2” to “MD1”. This change process is executed during a vertical blanking interval in synchronous with the vertical synchronization signal Vsync. As a result, the identification information of the memory device MD2 is registered in the registers R7 and R8, and the identification information of the memory device MD1 is registered in the registers R4, R9, and R10. Upon completion of the change of the memory allocation, the moving-image recording task is started in a step S13. As a result, the moving image representing the object scene is recorded in the recording medium 38 in a file format.

In a step S15, it is determined whether or not the moving-image-recording end operation is performed. In a step S17, it is determined whether or not the still-image recording operation is performed. When YES is determined in the step S17, the still-image recording process similar to that in the above-described step S9 is executed in a step S19. As a result, the object scene image at a time of performing the still-image recording operation is recorded in the recording medium 38 in a file format. Upon completion of the process in the step S19, the process returns to the step S15.

When the moving-image-recording end operation is performed, YES is determined in the step S15, and the moving-image recording task is stopped in a step S21. As a result, recording of the moving image to the recording medium 38 is ended, and then, the moving-image file is completed. In a step S23, the memory allocation is initialized, and upon completion of the initialization, the process returns to the step S5.

As understood from the above descriptions, the pre-processing circuit 18 repeatedly fetches the image data representing the object scene. The post-processing circuit 24, the video display circuit 26, and the H264 encoder 32 perform moving-image processes (the moving-image displaying mode; a post process and a video display, and the moving-image recording mode: a post process, a video display, and an H264 compression) on the image data fetched by the pre-processing circuit 18 according to a designated mode (the moving-image displaying mode or the moving-image recording mode). Furthermore, the post-processing circuit 24 and the JPEG encoder 34 perform still-image processes (the post-process and the JPEG compression) on one portion (=one frame) of the image data fetched by the pre-processing circuit 18. Therefore, amounts of the moving-image processes by the post-processing circuit 24, the video display circuit 26, and the H264 encoder 32 differ depending upon the operation mode.

The memory control circuits 20a and 20b respectively access the SDRAMs 22a and 22b in order to write and/or read out the image data related to the moving-image process (the YUV image data or the H264 data having 2 million pixels) and the image data related to the still-image process (the YUV image data or the JPEG data having 6 million pixels). The CPU 40 changes a memory control circuit responsible for the memory-access operation of the image data related to the still-image process, between the memory control circuits 20a and 20b depending upon an amount of the moving-image process (depending upon the operation mode) (S11 and S23).

More specifically, the memory access operation of the image data related to the moving-image process is carried out by the memory control circuit 20b. However, the H264 encoder 32 is started in the moving-image recording mode, but is stopped in the moving-image displaying mode. That is, the memory-access operation of the H264 data is executed only in the moving-image recording mode. The CPU 40 allocates the memory-access operation of the image data related to the still-image process to the memory control circuit 20b corresponding to the moving-image displaying mode, and to the memory control circuit 20a corresponding to the moving-image recording mode.

In the SDRAMs 22a and 22b, the image data related to the moving-image process and the image data related to the still-image process are accommodated. A content of the moving-image process relies on the designated mode, so that a load charged to the memory-access operation of the image data related to the moving-image process differs depending upon the mode. Considering this fact, in this embodiment, the memory control circuit responsible for the memory-access operation of the image data related to the still-image process is changed depending upon the designated mode. This change operation is realized by updating the identification information registered in the registers R4, R9, and R10. Thereby, it becomes possible to adaptively distribute the load charged to the memory-access operation between the memory control circuits 20a and 20b.

It is noted that in this embodiment, the CMOS-type imaging device is used, and however, instead thereof, a CCD-type imaging device may be used. Furthermore, in this embodiment, a video camera is assumed. However, the data-processing device according to the present invention may also be applied to devices other than the video camera.

Furthermore, in this embodiment, the memory allocation is performed according to a procedure shown in Table 1. However, combinations of the memory allocations are not limited to this example. That is, the allocation destination of one of the memory devices MD1 and MD2 may be replaced by the allocation destination of the other one of the memory devices MD1 and MD2 to each other. Furthermore, three or more memory devices and three or more data buses may be arranged.

More specifically, in this embodiment, the JPEG data generated in response to the still-image recording operation in the moving-image displaying mode is written to the SDRAM 22b, and the H264 data generated in response to the moving-image-recording operation is also written to the SDRAM 22b. However, the JPEG data generated under the moving-image displaying mode and the H264 data generated in response to the moving-image-recording operation may be written to the SDRAM 22a. In this case, a writing destination of the JPEG data generated in response to the still-image recording operation in the moving-image recording mode is the SDRAM 22b.

Additionally, in this embodiment, one pixel is expressed by 12 bits. However, one pixel may also be expressed by 14 bits.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image-data processing apparatus, comprising:
a fetcher for repeatedly fetching image data representing an object scene;
a moving-image processor for performing a moving-image process on the image data fetched by said fetcher;
a still-image processor for performing a still-image process on one portion of the image data fetched by said fetcher;
a plurality of accessors for respectively accessing a plurality of memories to write and/or read out the image data related to the process of each of said moving-image processor and said still-image processor; and
a changer for changing between said plurality of accessors a specific accessor responsible for a memory access operation of the image data related to the process of said still-image processor, depending upon a process amount of said moving-image processor.

2. An image-data processing apparatus according to claim 1, further comprising a determiner for determining whether or not the process amount of said moving-image processor changes, wherein said changer executes a change process when a determination result of said determiner is updated from a negative result to an affirmative result.

3. An image-data processing apparatus according to claim 1, wherein said fetcher fetches one screen of image data at each generation of a timing signal, and said changer executes a change process in synchronous with the timing signal.

4. An image-data processing apparatus according to claim 1, wherein the process amount of said moving-image processor differs depending upon an operation mode, and said changer changes said specific accessor according to the operation mode.

5. An image-data processing apparatus according to claim 4, wherein said moving-image processor includes: a convertor for converting a resolution of the image data fetched by said fetcher; a displayer for displaying an image based on the image data having the resolution converted by said convertor; and a first encoder for encoding, for recording, the image data having the resolution changed by said changer, said image-data processing apparatus further comprising a controller for starting said first encoder when a moving-image recording mode is designated whereas stopping said first encoder when a moving-image displaying mode is designated.

6. An image-data processing apparatus according to claim 5, wherein said plurality of accessors include a moving-image-use accessor responsible for memory access operations of both of the image data having the resolution converted by said convertor and the image data encoded by said first encoder, and said changer renders said specific accessor, an accessor different from said moving-image-use accessor, when the moving-image recording mode is designated, and renders said specific accessor, the same accessor as said moving-image-use accessor, when the moving-image displaying mode is designated.

7. An image-data processing apparatus according to claim 6, wherein said plurality of accessors further include a fetched-image-use accessor that is different from said moving-image-use accessor and is responsible for a memory access operation of the image data fetched by said fetcher.

8. An image-data processing apparatus according to claim 1, wherein said still-image processor includes an extractor for extracting one portion of the image data fetched by said fetcher and a second encoder for encoding, for recording, the image data extracted by said extractor.

9. An image-data processing apparatus according to claim 8, wherein said extractor extracts image data representing an object scene at a time of issuing a recording instruction.

10. An image-data processing apparatus according to claim 1, further comprising an imager, having an imaging surface irradiated with an optical image of an object scene, for repeatedly generating image data corresponding to said optical image, wherein said fetcher fetches the image data outputted from said imager.

11. A data-processing circuit, comprising:
a plurality of data buses respectively connected to a plurality of memory devices;
a first holder for holding first identification information for identifying, out of said plurality of memory devices, a memory device of a data-writing destination;
a second holder for holding second identification information for identifying, out of said plurality of memory devices, a memory device of a data-reading source;
a plurality of outputters, each of which executes a data-output process for outputting data from an output end corresponding to the first identification information held by said first holder, out of a plurality of output ends respectively connected to said plurality of data buses; and
a plurality of inputters, each of which executes a data-input process for inputting data from an input end corresponding to the second identification information held by said second holder, out of a plurality of input ends respectively connected to said plurality of data buses.

12. A data-processing circuit according to claim 11, further comprising a fetcher for fetching desired data, wherein said plurality of outputters include a fetched-data outputter for performing said data-output process on the data fetched by said fetcher.

13. A data-processing circuit according to claim 11, further comprising a first convertor for performing a first converting process on desired data, wherein said plurality of inputters include a first conversion data inputter for inputting data to be converted by said first convertor.

14. A data-processing circuit according to claim 13, wherein said plurality of outputters include a first conversion data outputter for performing said data-output process on data converted by said first convertor.

15. A data-processing circuit according to claim 11, further comprising an external outputter for outputting desired data to outside, wherein said plurality of inputters include an external-output-data inputter for inputting data to be outputted by said external outputter.

16. A data-processing circuit according to claim 11, further comprising a second convertor for performing a second converting process on desired data, wherein said plurality of inputters include a second conversion data inputter for inputting data to be converted by said second convertor.

17. A data-processing circuit according to claim 16, wherein said plurality of outputters include a second conversion data outputter for performing said data-output process on data converted by said second convertor.

18. An electronic device, comprising the data-processing circuit according to claim 11.
